(19) United States
(12) Patent Application Publication
(10) Pub. No.: US 2026/0095656 A1
(43) Pub. Date: Apr. 2, 2026

(54) Motion Blur Mitigation for Controller Tracking

(71) Applicant: Apple Inc., Cupertino, CA (US)

(72) Inventors: Joryl P. Calizo, San Jose, CA (US); Kaushik Raghunath, Pleasanton, CA (US); Timo Birnschein, Redwood City, CA (US); Yuhui Lai, Cupertino, CA (US)

(21) Appl. No.: 19/342,392

(22) Filed: Sep. 26, 2025

Related U.S. Application Data
(60) Provisional application No. 63/700,478, filed on Sep. 27, 2024.

(51) Int. Cl. H04N 23/68; G06F 3/01; G06V 10/141

(52) U.S. Cl. CPC H04N 23/689; G06F 3/014; G06V 10/141

(57) ABSTRACT

Hand-held controllers are instructed to illuminate in accordance with camera data. An exposure characteristic for a camera is predicted for additional frames. The exposure characteristic is predicted based on a current frame captured by the camera and one or more previous frames captured by the camera of a first device. An LED emission timing is determined for a controller device separate from the first device based on the predicted one or more exposure characteristics. The emission instruction is transmitted to the controller device in accordance with the LED emission timing. Future frames captured by the camera are used for determining positional information for the controller.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties.

Handheld controllers can be used in XR environments to enhance user input. Handheld controllers can be used as input systems to interact with the virtual environment. This can enhance the immersive experience and provide a more intuitive and natural way to interact with the virtual content. These controllers can be tracked by the system to provide input, for example based on illuminators on the controller. For example, image data of the controller can be captured to determine characteristics corresponding input. However, what is needed is improvements to track controllers.

### BRIEF DESCRIPTION OF THE DRAWINGS

FIG. 1A shows an example diagram of a user interacting with a controller having a set of illuminators in an extended reality environment, in accordance with some embodiments.

FIG. 1B shows an example diagram of a user interacting with a controller having markers in the form of retroreflective material, in accordance with one or more embodiments.

FIGS. 2A-2B show example image data of a hand based on emitter settings on the controller, in accordance with one or more embodiments.

FIG. 3 shows a flowchart of a technique for determining controller pose by tracking emitters, in accordance with one or more embodiments.

FIG. 4 shows a flowchart of a technique for generating an emission instruction for a controller, in accordance with some embodiments.

FIG. 5 shows a flowchart of a technique for determining an emission time, in accordance with some embodiments.

FIG. 6 shows a system diagram of an electronic device which can be used for controller tracking, in accordance with one or more embodiments.

FIG. 7 shows an exemplary system for use in various extended reality technologies.

### (a) DETAILED DESCRIPTION

This disclosure pertains to systems, methods, and computer readable media to enable controller tracking in an extended reality environment. In particular, techniques described herein are directed to adjusting the illumination settings for improved image capture for controller tracking.

In some enhanced reality contexts, handheld controllers can be used to generate user input. These handheld controllers may be tracked to determine characteristics of the motion or pose of the controller, which can then be translated into user input. As an example, a handheld controller may include one or more illuminators, such as light emitting diodes (LEDs), which can emit light that can be detected in the image data by a user device in order to track the controller. Similarly, other features of the controller can be tracked in image data to determine characteristics of the movement of the controller. As another example, a handheld controller may include retroreflective material which, when lit by one or more illuminators, can reflect light in a manner such that the controller can be tracked based on the detected locations of the material. However, when the illuminators cause a blur in the image data, the accuracy of the detected characteristics of the motion may suffer. In current technology, the cameras that are used to track the controller may be used for other image-based processing such as scene understanding, hand or body tracking, object detection, and the like. As such, the camera settings may be tied to non-controller processing. Further, the camera may use a rolling shutter technique to capture the images, which may result in motion blur artifacts when the controller or the camera moves rapidly. Motion blur may degrade the tracking accuracy and performance of the controller tracking system.

In some embodiments, a motion blur mitigation technique may be implemented to reduce or eliminate motion blur artifacts in the controller tracking system. The technique described herein involves predicting future exposure characteristics of cameras used for controller tracking in order to adjust illumination on the controller to improve controller tracking. In some embodiments, the device may use a camera to capture images of a controller that has one or more light-emitting diodes (LEDs) or other illuminators. The technique may involve predicting exposure characteristics for one or more future frames based on exposure characteristics for the camera as used to capture the current frame and one or more prior frames. In some embodiments, additional considerations may be used to predict the exposure characteristics, such as information about ongoing or planned camera use. This may be received, for example, from one or more motion sensors, such as one or more IMUs (inertial motion units), or the like. LED transmission timing for the controller may be determined based on the predicted exposure characteristics. The LED transmission timing may specify when and how long the LEDs should emit light in order to optimize or improve the image capture and tracking of the controller by reducing blur in the resulting image data. The technique may also involve transmitting an emission instruction to the controller based on the determined LED transmission timing. In some embodiments, the LED-based tracking may be used within multimodal tracking of the controller, and may be weighted against other sensor data collected by the device and/or the controller.

Techniques described herein provide a technical improvement to illuminator-based controller tracking by causing the illumination by controller to conform to expected camera settings in order to reduce blur. In turn, other camera-based processes can continue to use image data captured by the camera based on other settings. Accordingly, controller tracking can be improved while reducing effects to other systems relying on camera data.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description for purposes of explanation, numerous specific details are set forth in order to provide a thorough understanding of the disclosed concepts. As part of this description, some of this disclosure's drawings represent structures and devices in block diagram form, to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints) and that these goals may vary from one implementation to another. It will also be appreciated that such development efforts might be complex and time-consuming but would nevertheless, be a routine undertaking for those of ordinary skill in the design and implementation of graphics modeling systems having the benefit of this disclosure.

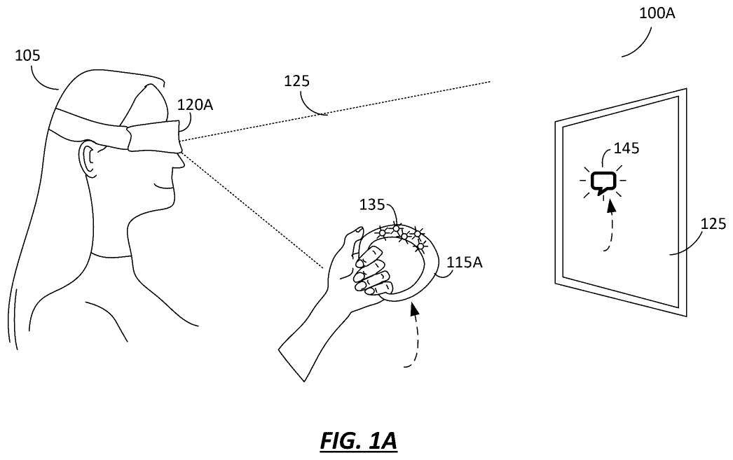

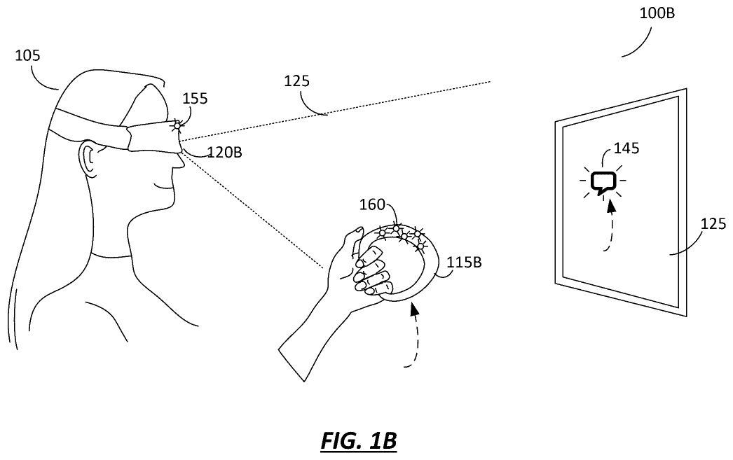

FIG. 1A is an example diagram illustrating an example of a controller tracking system, according to some embodiments. The diagram 100A includes a user 105 using a controller 115 for user input by using a controller tracking functionality of an electronic device 120A. Although electronic device 120A is shown as a head-mounted device (HMD), other example devices include a smartphone, a tablet, a laptop, a desktop, a gaming console, or any other suitable device. The electronic device 120A may include one or more cameras which can be used to capture image data from which the controller 115A can be tracked. Example cameras include depth cameras, infrared cameras, visible light cameras, or any other suitable cameras. The controller 115A may be a handheld device, such as a wand, a glove, a ring, a baton, or any other suitable device, that is used to interact with an application running on the electronic device 120A based on detected motion of the controller 115A. Example relevant applications include a gaming application, a virtual reality application, an augmented reality application, or any other suitable application that utilizes the controller 115A as an input device. In the example shown above, the motion of the controller 115A is used to drag an icon 145 on a virtual display 125 in an extended reality environment, for example using augmented reality, virtual reality, enhanced reality, or the like.

The controller 115A may include one or more illuminators 135, such as LEDs or any other suitable light sources that emit light in a pattern or sequence that can be adjusted. The illuminators 135 may be arranged in a predefined constellation or other configuration that enables the device 120A to identify and track the controller 115A based on the emitted light detected in captured images, for example within a field of view 125 of a camera of the device.

In some embodiments, the illuminator-based tracking technique may be used as part of a multimodal tracking process. To that end, the controller 115A may also include a motion sensor, such as an accelerometer, a gyroscope, a magnetometer, or any other suitable sensor, which detects the motion and orientation of the controller 115A. The motion sensor may provide motion data which may be used in conjunction with the illuminator-based tracking to determine position and/or orientation of the controller 115A. As another example, the device 120A may additionally use hand tracking, object tracking, or other techniques to contribute to the determination of the position and/or orientation of the controller 115A.

According to some embodiments, the camera or cameras of device 120A may be used by multiple functions or pipelines for different functionality such as scene understanding, tracking, image or video capture, or the like. To that end, the camera settings may dynamically change based on the requirements of processes utilizing image data captured by the camera or cameras. Thus, in some embodiments, the device 120A may predict future exposure parameters for upcoming frames based on prior exposure data and/or expected or ongoing image processing tasks for which image data is or will be captured by the camera or cameras. The predicted exposure parameters can then be used to preemptively instruct the controller to adjust illumination patterns based on the expected camera settings. The emission instruction may include, for example, a start time, a duration, a frequency, an intensity, a color, or any other suitable parameters that indicate how the illuminators 135 should emit light for improved image capture based on expected camera settings, such as exposure parameters. The emission instruction may be transmitted from the device 120A to the controller 115A via a wired or wireless connection, such as Bluetooth, Wi-Fi, or any other suitable protocol.

FIG. 1B shows an alternative example where a user example diagram illustrating an example of a controller tracking system, according to some embodiments. The diagram 100B includes a user 105 using a controller 115B for user input by using a controller tracking functionality of an electronic device 120B. Again, although electronic device 120B is shown as an HMD, other example devices include a smartphone, a tablet, a laptop, a desktop, a gaming console, or any other suitable device. The electronic device 120B may include one or more cameras which can be used to capture image data from which the controller 115B can be tracked. In addition, the electronic device 120B may additionally include one or more emitters 155, such as infrared (IR) emitters. Each of the IR emitters may have a same or different coverage area outward toward the environment. In some embodiments, the controller 115B may include one or more markers 160 composed of retroreflective material, such that when the emitters 155 are activated, the reflection from the markers 160 can be captured in image data captured by cameras of the electronic device 120B.

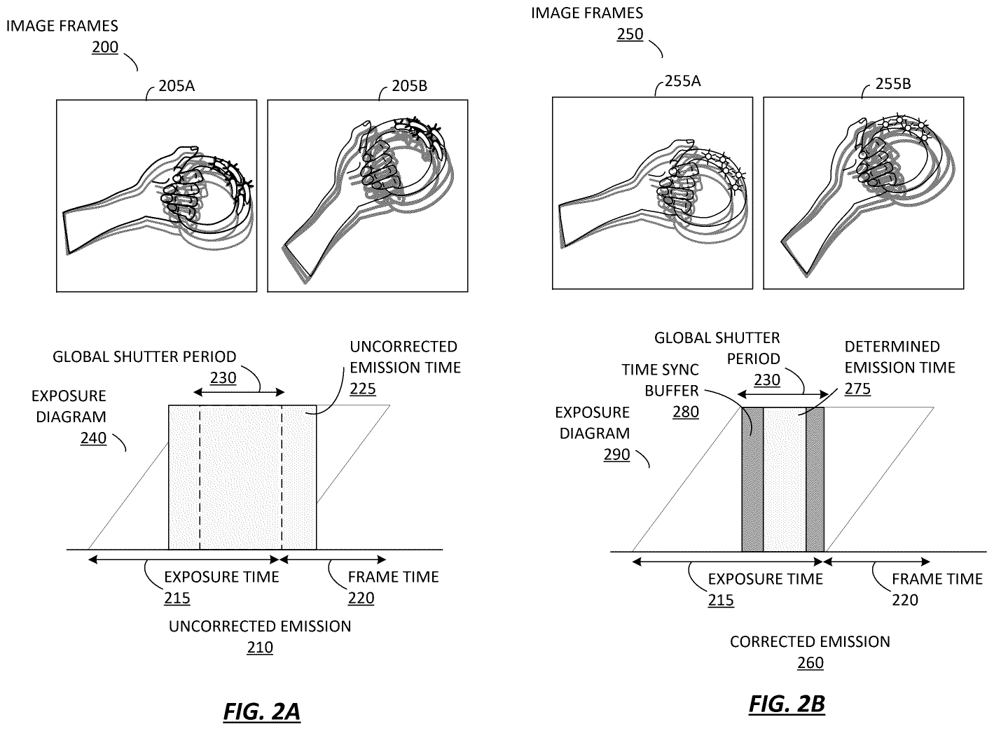

FIGS. 2A-2B show example image data of a handheld controller based on emitter settings on the controller, in accordance with one or more embodiments. In particular, FIG. 2A shows an example view of image data and exposure when illuminators are not adjusted, whereas FIG. 2B shows an example view of image data and exposure when illuminators are adjusted for predicted camera settings and/or exposure parameters.

In FIG. 2A, a set of image frames 200 are captured without correction of the illuminators for predicted exposure parameters. For purposes of the example, image frames 200 correspond to the user and controller motion described above with respect to FIGS. 1A-1B. In this example, the emitters are active longer than a global shutter period, resulting in the emitter or marker on the controller being captured at multiple positions during the camera shutter time, thereby causing a blur in frame 205A and frame 205B.

The blur presented in the frames is explained when considering exposure diagram 240. For purposes of this example, a rolling shutter exposure is used. However, it should be understood that one or more embodiments described herein could apply to cameras with global shutters or other configurations. Cameras with a rolling shutter cause rows of pixels to integrate at different times. As shown in exposure diagram 240, an exposure time 215 indicates a length of time in which one or more row integrates, whereas frame time 220 indicates a length of time in which one or more row does not integrate. The rows integrate on a rolling process, meaning that at times, not all rows integrate at the same time. In some instances, all rows do integrate at a same time. This is considered the global shutter period 230, during which the rolling shutter camera acts as a global shutter camera. However, in some embodiments, the combination of exposure time 215 and frame time 220 may cause a scenario in which no global shutter period exists.

In some embodiments, a blur may occur in the image frames 200 when the uncorrected emission causes the illuminators to emit light longer than the global shutter period 230, as shown in uncorrected emission diagram 210. That is, the motion of the controller will be captured by some rows differently than other rows. This is shown as uncorrected emission time 225 exceeds the global shutter period 230. Because controller tracking can rely on determining a change in position of the illuminators across frames, the blur can introduce challenges in determining a change in position and/or orientation from frame 205A to 205B.

By contrast, turning to FIG. 2B, image frames 250 are presented. The image frames 250 include image frame 255A and 255B, reflecting the user and controller motion of FIGS. 1A-1B. In this scenario, the illuminators are distinctly visible. According to one or more embodiments, the result is achieved without adjusting camera settings and, instead, adjusting illuminator settings based on expected exposure parameters. Here, the exposure diagram 290 shows corrected emission 260. A determined emission time 275 is determined based on the global shutter period 230. In some embodiments, the determined emission time 275 may be shorter than the global shutter period 230 to account for a synchronization buffer 280 between the device and the controller. Because the determined emission time 275 is less than the global shutter period, all rows capture the illuminators for the same amount of time, resulting in clearer, less blurry imaging of the illuminators. Accordingly, controller tracking can more accurately rely on a determined change in position and/or orientation of the illuminators from frame 255A to frame 255B.

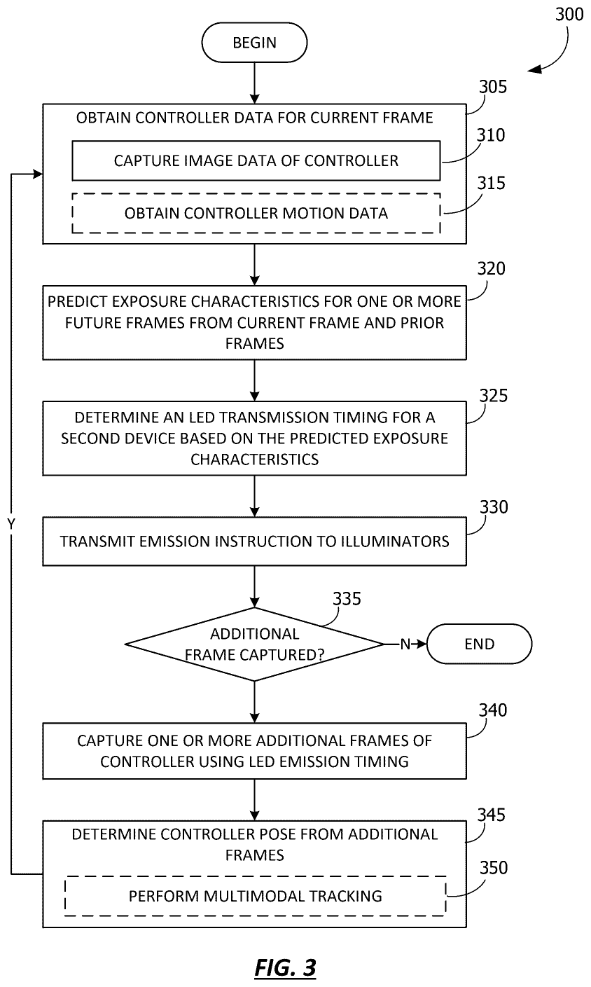

FIG. 3 shows a flowchart of a technique for determining controller pose by tracking emitters, in accordance with one or more embodiments. In particular, FIG. 3 shows a technique for providing emission instructions to illuminators to facilitate controller tracking, in accordance with one or more embodiment. Although the flowchart describes various components as performing particular processes, it should be understood that the flow of the diagram may be different in accordance with some embodiments, and the functionality of the components may be different in accordance with some embodiments. Further, the various process may be performed in a different order.

The flowchart 300 begins at block 305, where controller data for a current frame is obtained. In some embodiments, as shown at block 310, controller data may include image data of a controller (e.g., controller 115 shown in FIG. 1). The image data may include, for example, pixel values, color values, depth values, or any other suitable data that captures an image of the controller in the current frame. The image data may be captured by a camera using a rolling shutter technique, where different rows of the camera sensor may be exposed at different times.

Optionally, at block 315, obtaining controller data for the current frame may include obtaining controller motion data. The controller motion data may include, for example, acceleration, angular velocity, or any other suitable data that indicates the position and/or orientation of the controller. The controller motion data may be obtained from one or more sensors in the controller, or from another suitable source. The current frame may be a frame that is being captured or processed by the camera 130 at a given time. In some embodiments, the controller motion data may or may not have a timing relationship with the tracking cameras. For example, motion sensors may be sampled at a higher sampling rate than cameras. Further, in some embodiments, motion data of the controller determined from the image data may be enhanced by the controller motion data.

At block 320, the flowchart 300 includes predicting exposure characteristics for one or more future frames from the current frame and one or more prior frames. The exposure characteristics may include, for example, mid-exposure time, integration time, frame time, or any other suitable parameters that indicate the exposure settings of the camera. The current frame exposure characteristics may be the camera settings used to capture image data at block 310. One or more sets of exposure characteristics may be recalled from one or more prior frames. The future frames may be frames that are to be captured or processed by the camera after the frame captured at block 310. The prediction may be performed by the current and historic exposure parameters, as well as other data indicative of an ongoing or upcoming change in exposure parameters. For example, the prediction process may consider ISP data from the ISP of the camera 130, system-wide timing sync generator data from the various sensors in the device, or the like. In some embodiments, the system-wide timing sync generator may be a master sync generator (MSG). In particular, the system-wide timing sync generator may be a source of truth for future camera frame rate or phase changes. The prediction process may use various models, algorithms, or techniques, such as machine learning, or any other suitable methods, to predict the exposure characteristics for future frames.

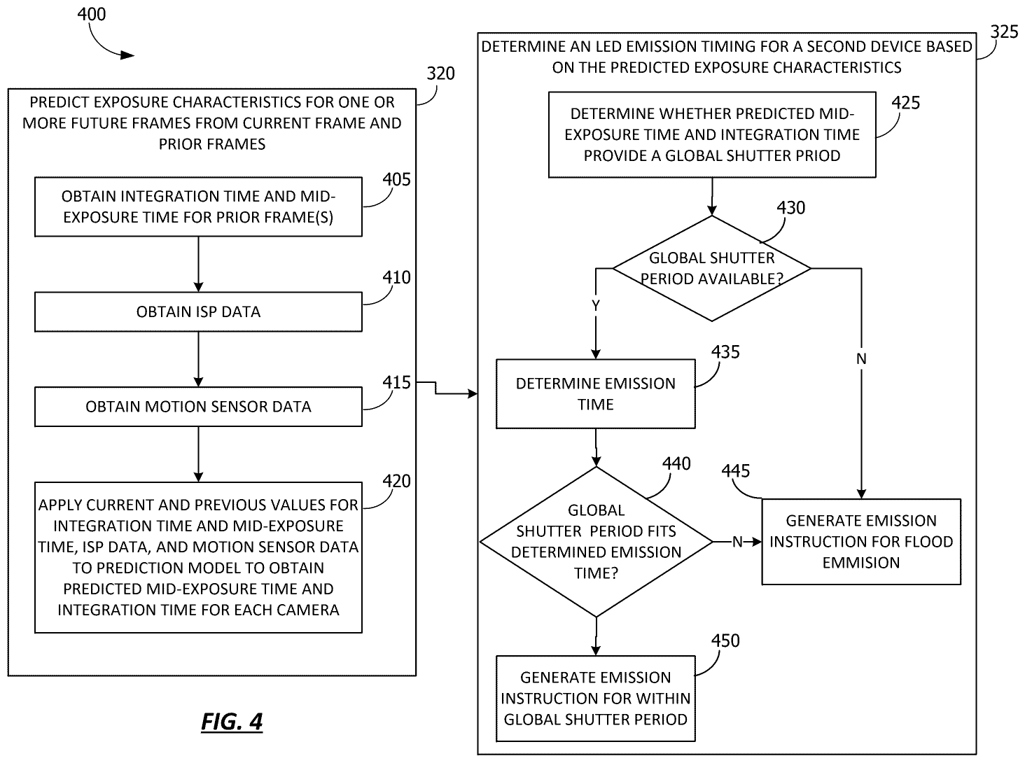

At block 325, the flowchart 300 includes determining an LED transmission timing for the controller based on the predicted exposure characteristics. The LED transmission timing may specify when and how long the illuminators on the controller should emit light in order to optimize the image capture and tracking of the controller. The LED transmission timing may be determined based on various data regarding the device and/or controller, such as the predicted exposure characteristics obtained at block 320, a target integration ratio, a minimum emission duration, a maximum emission duration, or the like. The determination may also use various models, algorithms, or techniques, such as optimization, heuristics, or any other suitable methods, as described below with respect to FIG. 4.

The flowchart 300 proceeds to block 330. At block 330, an emission instruction is transmitted to the emitters based on the LED transmission timing. The emission instruction may include, for example, a start time, a duration, a frequency, an intensity, a color, or any other suitable parameters that indicate how the illuminators 135 should operate. In some embodiments, the emission instruction may be sent within a device, such as an HMD device having one or more cameras and one or more emitters. Alternatively, the emission instruction may be transmitted to an additional device, such as the controller device to cause the controller to trigger an emitter, such as a flood emitter configured to illuminate a large physical area compared to other emitters. For example, the emission instruction may be transmitted by the device via a wired or wireless connection, such as Bluetooth, Wi-Fi, or any other suitable protocol.

At block 335, the flowchart 300 includes a determination as to whether any additional frames are captured. If no additional frames are captured, then the flowchart ends, as the controller is no longer being tracked. That is, the final emission instructions may be transmitted for future frames which are never captured because the emission instructions are based on predicted camera settings.

Returning to block 335, if additional frames are captured, then the flowchart 300 proceeds to block 340. At block 340, the method 300 may capture one or more additional frames of the controller while the emitters are using the LED emission timing. The additional frames may be frames that are captured or processed by the camera after the current frame and before the next current frame. In some embodiments, the emission instructions may be transmitted with a delay, such that the image captured using the LED emission timing is not the immediate next frame captured, but a future frame after the emission instructions are transmitted.

The flowchart 300 proceeds to block 345, where the pose of the controller is determined from the additional frames, such as the frames captured at block 340. The pose may include, for example, the position and/or orientation of the controller. Optionally, as shown at block 350, multimodal tracking may be performed to track the controller. Multimodal tracking may use the captured images from block 340 and additional sensor data. In some embodiments, the multimodal tracking technique may involve combining or fusing data from different sources, such as the camera, a motion sensor in the controller, or other data, to determine the pose of the controller. The multimodal tracking may also involve weighting or adjusting the data from different sources based on their reliability, accuracy, or confidence. For example, the controller pose determined from the additional frames at block 345 may be weighted in accordance with a confidence value determined for the positional information such as position and/or orientation. As another example, the controller pose data from the additional frames may be weighted based on characteristics of the emission instruction transmitted to the controller. For example, if the emission instructions direct the controller to emit light during a determined time period, the pose information may be more reliable, and weighted more heavily, than if the emission instruction directs the controller to perform a flood light operation.

FIG. 4 shows a flowchart of a technique for generating an emission instruction for a controller, in accordance with some embodiments. In particular, the flowchart presented in FIG. 4 depicts an example technique for determining characteristics of an emission instruction. For purposes of explanation, the following steps will be described as being performed by particular components. However, it should be understood, that the various actions may be performed by alternate components. In addition, the various actions may be performed in a different order. Further, some actions may be performed simultaneously, and some may not be required, or others may be added.

The flowchart begins with predicting exposure characteristics at block 320 from FIG. 3. At block 405, the flowchart 400 includes obtaining an integration time and mid-exposure time for prior frame(s). The integration time and mid-exposure time may be obtained from metadata related to the prior frames, or may be received from another suitable source, such as an image processing pipeline that generates the metadata, a system-wide timing/sync generator. The prior frame(s) may be one or more frames that are captured or processed by the camera before the current frame. In some embodiments, the integration time and mid-exposure time may be obtained for each camera for which image data is used to track the controller. For example, if the device uses a stereoscopic camera system, the integration time and mid-exposure time may be determined for each camera.

The flowchart 400 proceeds to block 410, where ISP data is obtained. The ISP data may include data from an image signal processor of the camera, such as auto exposure data, or any other relevant data that indicates the exposure parameters of the camera. In addition, at block 415, motion sensor data may be obtained. The motion sensor data may include data from a motion sensor group of the device, such as accelerometer data, gyroscope data, magnetometer data, or any other suitable data that indicates the motion and orientation of the camera. In some embodiments, the motion sensor data may indicate characteristics that affect the operation of the camera, such as head motion, device motion, or the like which may affect frame rate or otherwise may affect exposure parameters.

At block 420, the flowchart 400 includes applying the current and previous values for integration time and mid-exposure time, ISP data, and motion sensor data to a prediction model to obtain predicted mid-exposure time and integration time for each camera. The prediction model may be a linear regression model, a machine learning model, or any other suitable model that predicts the exposure characteristics for one or more future frames based on the current frame and prior frames. In some embodiments, the model may further be configured to predict a confidence value for the predicted mid-exposure time and/or integration time.

The flowchart 400 then proceeds to block 325 of FIG. 3, generally regarding determining an LED transmission timing for the controller. In particular, at block 425, the flowchart 400 includes determining whether the predicted mid-exposure time and integration time provide a global shutter period for each camera. The global shutter period may be a period of time within the camera exposure where all rows of the camera sensor are integrating light simultaneously. The global shutter period may be determined by subtracting a frame time from an integration time. The global shutter period may further be constrained based on time sync error, determined at runtime or via heuristic data. A determination is made at block 430 as to whether the global shutter period is available. If the global shutter period is available for each camera, the flowchart 400 may proceed to block 435.

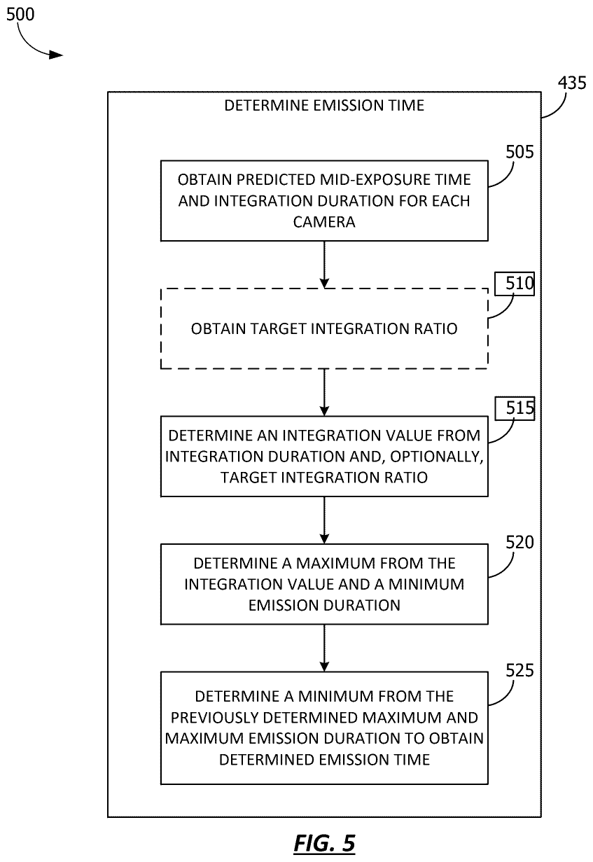

At block 435, the flowchart 400 includes determining an emission time. The determined emission time may be an emission time that is equal to or less than the global shutter period, and that satisfies a target integration ratio. The determined emission time indicates a determined illumination time and duration based on the predicted exposure parameters. Examples of techniques for determining an emission time will be described in greater detail below with respect to FIG. 5.

The flowchart proceeds to block 440, where a determination is made as to whether the global shutter period fits the determined emission time. In some embodiments, determining whether the global shutter period fits the determined emission time may include determining whether the global shutter period satisfies a combination of the idea emission time and an additional time sync buffer to take into consideration issues related to latency between the two devices. If a determination is made at block 440 that the global shutter period fits the determined emission time, the flowchart 400 concludes at block 450 and the system may generate an emission instruction for an adjusted LED emission setting such that emission occurs within global shutter period. For example, the emission timing may include emission around the predicted mid-exposure value, and for the determined emission time.

Returning to block 440, if a determination is made that the global shutter period does not fit the determined emission time, the flowchart concludes at block 445 and the device may generate an emission instruction for flood emission. The device may also generate an emission instruction for flood emission if at block 430 a determination is made that the global shutter period is not available. The flood emission may cause the duration of the LED emission period at the controller to cover the entire integration time or a substantial portion thereof. The flood emission may ensure that the LED emission is captured by all rows of the camera sensor, but may result in overexposure or underexposure of the LED emission, depending on the brightness of the environment and the motion of the controller. The flood emission may also consume more power and generate more heat than the determined emission scenario.

FIG. 5 shows a flowchart of a technique for determining an emission time, in accordance with some embodiments. For purposes of explanation, the following steps will be described as being performed by particular components. However, it should be understood, that the various actions may be performed by alternate components. In addition, the various actions may be performed in a different order. Further, some actions may be performed simultaneously, and some may not be required, or others may be added.

At block 505, the flowchart 500 may obtain predicted mid-exposure time and integration time for each camera. The predicted mid-exposure time and integration time may be obtained from the exposure prediction technique described above, for example with respect to block 420 of FIG. 4. The predicted mid-exposure time and integration time may indicate the predicted exposure parameters of the camera for one or more future frames. In some embodiments, the predictions may be made for each camera, for example of a stereo camera system.

At optional block 510, the flowchart 500 includes obtaining a target integration ratio. The target integration ratio may be a predefined value, or may be a tuned value, for example by a user, an application using the controller, or the like. The target integration ratio may indicate a desired ratio between the LED emission time and the integration time. The flowchart 500 continues at block 515, where the system may determine an integration value from the integration time and, optionally, the target integration ratio. For example, the integration value may be determined by multiplying the target integration ratio with the integration time. Alternatively, the integration duration may be used as the integration value.

At block 520, the flowchart 500 includes determining a maximum from among the integration value determined at block 515, and a minimum emission duration. The minimum emission duration may be a predefined or configurable value that indicates the lower bound of the acceptable emission time for the controller. In some embodiments, the minimum emission duration may be predefined. For example, the minimum emission duration may be provided by a controller manufacturer or other party associated with the controller. Alternatively, the minimum emission duration may be selected by a user, or may be directed by an application using the user input from the tracked controller. The maximum may be determined by selecting the larger value between the integration value and the minimum emission duration.

The flowchart 500 proceeds to block 525, where a minimum is determined from the previously determined maximum from block 520, and a maximum emission duration. The maximum emission duration may be a predefined or configurable value that indicates the upper bound of the acceptable emission time. The maximum emission duration may be selected by a user, or may be directed by an application using the user input from the tracked controller The minimum may be determined by selecting the smaller value between the previously determined maximum and the maximum emission duration. The minimum identified at block 525 may be the determined emission time.

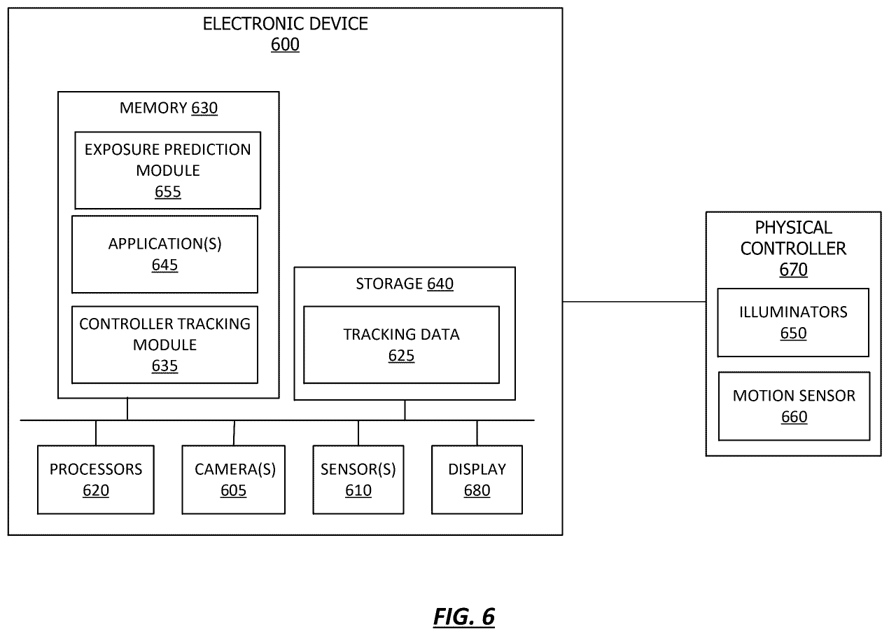

Referring to FIG. 6, a simplified system diagram is depicted. In particular, the system includes electronic device 600 and physical controller 670. Electronic device 600 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 600 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 600 is utilized to interact with a user interface of an application. It should be understood that the various components and functionality within electronic device 600 may be differently distributed across the modules or components, or even across additional devices.

Electronic device 600 may include one or more processors 620, such as a central processing unit (CPU) or graphics processing unit (GPU). Electronic device 600 may also include a memory 630. Memory 630 may include one or more different types of memory, which may be used for performing device functions in conjunction with processor(s) 620. For example, memory 630 may include cache, ROM, RAM, or any kind of transitory or non-transitory computer-readable storage medium capable of storing computer-readable code. Memory 630 may store various programming modules for execution by processor(s) 620, including exposure prediction module 655, controller tracking module 635, and one or more application(s) 645.

Exposure prediction module 655 may be used to predict exposure parameters for one or more cameras of the electronic device 600 in future frames, such as camera(s) 605. Exposure prediction module 655 may use data from cameras 605 and/or other sensors 610 of the electronic device 600 to predict future exposure parameters. Controller tracking module 635 may direct the physical controller to activate illuminators 650 using a determined timing. In addition, controller tracking module 635 may analyze image data, for example captured by camera(s) 605 to determine position and/or orientation information for the physical controller 670. The position and/or orientation information from the physical controller may be combined with additional data, for example from motion sensor 660 of the physical controller 670 or other data in a multimodal tracking process. The position and/or orientation information may then be used for user input, for example for application(s) 645.

Electronic device 600 may also include storage 640. Storage 640 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 640 may be utilized to store various data and structures which may be utilized for storing data related to controller tracking. In addition, storage 640 may be configured to store enrollment data 625 for a user which may include user-specific characteristics used for controller tracking.

In one or more embodiments, each of the one or more cameras 605 may be a traditional RGB camera or a depth camera. Further, cameras 605 may include a stereo camera or other multicamera system. In addition, electronic device 600 may include other sensors which may collect sensor data for tracking user movements, such as a depth camera, infrared sensors, or orientation sensors, such as one or more gyroscopes, accelerometers, and the like.

Electronic device 600 may also include a display 680 which may present a UI for interaction by a user. Display 680 may be an opaque display or may be semitransparent or transparent. Display 680 may incorporate LEDs, OLEDs, a digital light projector, liquid crystal on silicon, or the like.

Although electronic device 600 is depicted as comprising the numerous components described above, in one or more embodiments, the various components may be distributed across multiple devices. Accordingly, although certain calls and transmissions are described herein with respect to the particular systems as depicted in one or more embodiments, the various calls and transmissions may be made differently directed based on the differently distributed functionality. Further, additional components may be used, some combination of the functionality of any of the components may be combined.

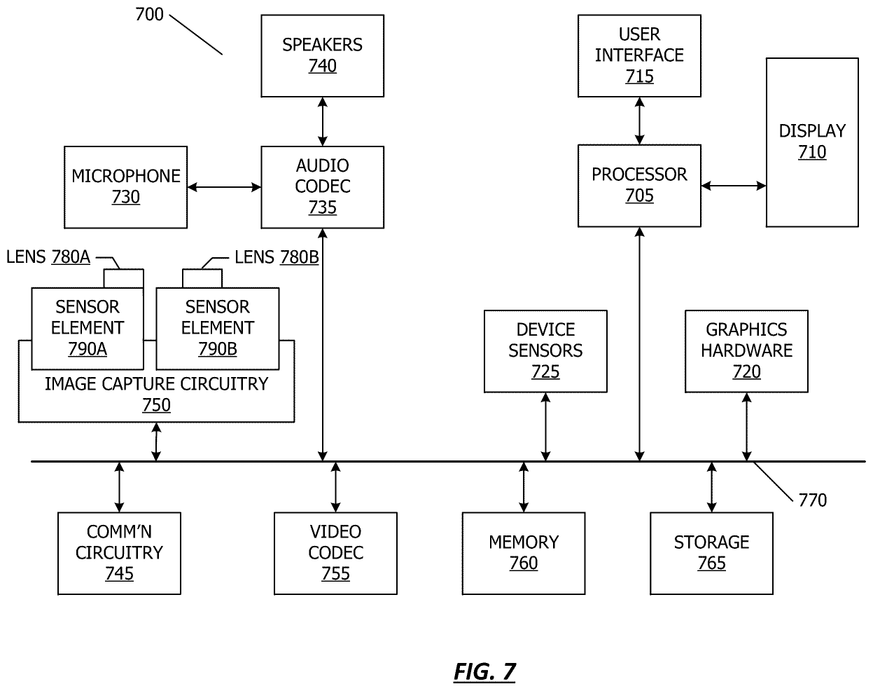

Referring now to FIG. 7, a simplified functional block diagram of illustrative multifunction electronic device 700 is shown according to one embodiment. Each of electronic devices may be a multifunctional electronic device or may have some or all of the described components of a multifunctional electronic device described herein. Multifunction electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture circuitry 750 (e.g., including camera system), video codec(s) 755 (e.g., in support of digital image capture unit), memory 760, storage device 765, and communications bus 770. Multifunction electronic device 700 may be, for example, a digital camera or a personal electronic device such as a personal digital assistant (PDA), personal music player, mobile telephone, or a tablet computer.

Processor 705 may execute instructions necessary to carry out or control the operation of many functions performed by device 700 (e.g., such as the generation and/or processing of images as disclosed herein). Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen, touch screen, gaze, and/or gestures. Processor 705 may also, for example, be a system-on-chip such as those found in mobile devices and include a dedicated GPU. Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include two (or more) lens assemblies 780A and 780B, where each lens assembly may have a separate focal length. For example, lens assembly 780A may have a short focal length relative to the focal length of lens assembly 780B. Each lens assembly may have a separate associated sensor element 790A and sensor element 790B. Alternatively, two or more lens assemblies may share a common sensor element. Image capture circuitry 750 may capture still and/or video images. Output from image capture circuitry 750 may be processed by video codec(s) 755 and/or processor 705 and/or graphics hardware 720, and/or a dedicated image processing unit or pipeline incorporated within circuitry 750. Images so captured may be stored in memory 760 and/or storage 765.

Image capture circuitry 750 may capture still, and video images that may be processed in accordance with this disclosure, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random-access memory (RAM). Storage 765 may store media (e.g., audio, image and video files), computer program instructions or software, preference information, device profile information, and any other suitable data. Storage 765 may include one more non-transitory computer-readable storage mediums including, for example, magnetic disks (fixed, floppy, and removable) and tape, optical media such as CD-ROMs and DVDs, and semiconductor memory devices such as EPROM and EEPROM.

Memory 760 and storage 765 may be used to tangibly retain computer program instructions, or code organized into one or more modules and written in any desired computer programming language. When executed by, for example, processor 705 such computer program code may implement one or more of the methods described herein.

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-5, or the arrangement of elements shown in FIGS. 1 and 6-7 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
predicting, based on a current frame and a previous frame captured by a camera of a first device, an exposure characteristic for the camera for an additional frame to obtain a predicted exposure characteristic;
determining an adjusted LED emission setting for a second device based on the predicted exposure characteristic; and
transmitting, by the first device, an emission instruction to the second device in accordance with the adjusted LED emission setting,
wherein positional information for the second device is determined based on an LED emission captured in the additional frame by the camera.

2. The method of claim 1, wherein the adjusted LED emission setting differs from an current LED emission setting for the second device.

3. The method of claim 1, wherein the positional information for the second device is determined using multimodal tracking, wherein the positional information for the second device is weighted against additional positional information using an additional tracking mode.

4. The method of claim 3, wherein the positional information for the second device is weighted against the additional positional information based on the predicted exposure characteristic.

5. The method of claim 3, wherein the additional tracking mode comprises one or more of visual tracking performed by the first device and motion sensor data received from the second device.

6. The method of claim 1, wherein predicting the exposure characteristic comprises determining a target camera exposure based on an active process on the first device using the camera.

7. The method of claim 6, wherein the camera is a rolling shutter camera, and wherein determining the LED emission timing for the second device comprises determining a target exposure period during which all rows of a camera sensor for the rolling shutter camera are integrating simultaneously.

8. A non-transitory computer readable medium comprising computer readable code executable by one or more processors to:
predict, based on a current frame and a previous frame captured by a camera of a first device, an exposure characteristic for the camera for an additional frame to obtain a predicted exposure characteristic;
determine an adjusted LED emission setting for a second device based on the predicted exposure characteristic; and
transmit, by the first device, an emission instruction to the second device in accordance with the adjusted LED emission setting,
wherein positional information for the second device is determined based on an LED emission captured in the additional frame by the camera.

9. The non-transitory computer readable medium of claim 8, wherein the adjusted LED emission setting differs from a current LED emission setting for the second device.

10. The non-transitory computer readable medium of claim 8, wherein the position information for the second device is determined using multimodal tracking, wherein the positional information for the second device is weighted against additional positional information using an additional tracking mode.

11. The non-transitory computer readable medium of claim 10, wherein the positional information for the second device is weighted against the additional positional information based on the predicted exposure characteristic.

12. The non-transitory computer readable medium of claim 10, wherein the additional tracking mode comprises one or more of visual tracking performed by the first device and motion sensor data received from the second device.

13. The non-transitory computer readable medium of claim 8, wherein the computer readable code to predict predicting the exposure characteristic comprises computer readable code to:
determine a target camera exposure based on an active process on the first device using the camera.

14. The non-transitory computer readable medium of claim 13, wherein the computer readable code to determine the LED emission timing for the second device comprises computer readable code to, in response to a determination that the target camera exposure satisfies a flood emission parameter:
generate an emission instruction to cause the second device to emit light throughout an exposure period.

15. The non-transitory computer readable medium of claim 13, wherein the camera is a global shutter camera.

16. A system comprising:
one or more processors; and
one or more computer readable media comprising computer readable code executable by the one or more processors to:
predict, based on a current frame and a previous frame captured by a camera of a first device, an exposure characteristic for the camera for an additional frame to obtain a predicted exposure characteristic;
determine an adjusted LED emission setting for a second device based on the predicted exposure characteristic; and
transmit, by the first device, an emission instruction to the second device in accordance with the adjusted LED emission setting,
wherein positional information for the second device is determined based on an LED emission captured in the additional frame by the camera.

17. The system of claim 16, wherein the position information for the second device is determined using multimodal tracking, wherein the positional information for the second device is weighted against additional positional information using an additional tracking mode.

18. The system of claim 16, wherein the positional information for the second device is weighted against the additional positional information based on the predicted exposure characteristic.

19. The system of claim 18, wherein the additional tracking mode comprises one or more of visual tracking performed by the first device and motion sensor data received from the second device.

20. The system of claim 16, wherein the computer readable code to predict predicting the exposure characteristic comprises computer readable code to:
determine a target camera exposure based on an active process on the first device using the rolling shutter camera.
